(19) United States
(12) Patent Application Publication
(10) Pub. No.: US 2010/0116744 A1
(43) Pub. Date: May 13, 2010

(54) Device For The Rotor-Stator Homogenization Of Heterogeneous Samples And Use Of Such

(76) Inventor: Frank Vitzthum, Lahntal-Sterzhausen (DE)

Correspondence Address: Dr. Frank Vitzthum, Sandweg 6a, 35094 Lahntal-Sterzhausen, DE

(21) Appl. No.: 11/988,104

(22) PCT Filed: Jun. 28, 2006
(86) PCT No.: PCT/EP2006/006249

§ 371 Date: Jan. 12, 2010

(30) Foreign Application Priority Data
Jul. 4, 2005 (DE) 10 2005 031 459.7

(51) Int. Cl. B01F 3/00; B01F 7/00; B01D 15/22

(52) U.S. Cl. 210/657; 366/279; 210/198.2

(57) ABSTRACT

Disclosed is a rotor-stator homogenization device which is characterized in that a rotor-stator homogenizer is connected to a reaction vessel via a joining system, and/or homogenization surfaces are used, and/or a rotor-stator homogenizer is used that is suitable for transferring material. Also disclosed is a method which utilizes said device and is characterized in that the reproducibility, efficiency, yield, waste disposal, automation of the rotor-stator homogenization, etc. is improved, for example, while the risk of contaminations is reduced.

The present invention relates to a device for homogenization of inhomogeneous samples, particularly for homogenization or disintegration of immiscible or hardly miscible liquids or solid materials.

In general, rotor-stator-homogenizer consist of an outer shank pipe, the so called stator, and an inner pivot-mounted rotor shaft. This rotor shaft is usually driven by an engine via a coupling. Homogenization of samples is achieved through milling regions of the rotor and the stator by the rotation of the rotor. In general, the rotor-stator-homogenizer is manually placed in a reaction tube or a homogenization tube which contains the sample and possibly a solution for disintegration. In this setting, the position of the rotor-stator-homogenizer is not defined and therefore the reproducibility of homogenization processes is restricted.

Samples to be homogenized are for example suspensions or emulsions of immiscible liquids. The ability to homogenize such samples is of great interest in various fields for example in the production of food, cosmetics, pharmaceuticals, and colors, etc. Rotor-stator-homogenizers can also be used to homogenize solid samples, e.g. in order to prepare the sample material for analytical purposes. For example, sewage sludge is homogenized using rotor-stator-homogenizers before analysis. Also other organic materials like tissues from plants or animals are homogenized for their analysis by rotor stator homogenizers. For example, rotor-stator-homogenizers are used in the sample preparation to determine prions in brain tissue. Consequently, rotor-stator-homogenizers play an important role in the detection of transmissible spongiform encephalopathies.

However, due to the high rotating speed, spillage of the sample within and as the case may be even out of the reaction tube usually occurs. This leads to loss and a reduction of yield and bears the risk of contamination, which is undesirable not only when working with infectious material but also when working with radioactive and/or toxic substances. Further problems are for example poor reproducibility, too low homogenizing efficiency, poor automation, cumbersome and low efficient transfer of reagents, solutions, and homogenate, etc.

Point of the present invention was therefore to furnish a device that allows for a more efficient homogenization of liquid and solid samples. The solution of this question lies within the provision of the objects and processes claimed.

The present invention reduces or prevents the spillage of sample material and therefore lowers the risk of contamination. Furthermore, the invention offers the advantages to achieve higher yields and better reproducibility. This is of particular importance for diagnostic applications. In addition and according to the invention the condition of the rotor-stator-homogenizer, of the reaction vessel or the homogenization vessel, their connection via a connection system and/or the respective combination or a rotor-stator-homogenizer, a reaction vessel and/or connection system as well as respective processes, achieve a faster and more efficient homogenization. For example, the unexpected, efficient rotor-stator-homogenization of microorganisms, like Escherichia coli (E. coli), was possible. In addition, the invention offers the opportunity to combine in a cost-effective manner reusable rotor-stator-homogenizers with disposable vessels as the case may be including homogenizing particles and/or disintegration solutions, i.e. a ‘homogenization kit’. This possibility opens a profitable option for commercialization of ‘homogenization kits’ for customers with respective rotor-stator-homogenizers.

The possibility of this cost-saving combination as well as the increased efficiency and effectiveness to homogenate samples is an advantage over the known disposable-rotor-stator-homogenizers and the entire disposable systems.

The present invention regards a device to homogenize inhomogeneous samples, whereas the rotor-stator-homogenizer is joined with the reaction tube in a manner which prevents or at least reduces spillage of the sample out of the vessel and/or whereas the rotor-stator-homogenizer is connected with the reaction vessel in a defined manner, so that for example surprisingly the efficiency of homogenization and the yield are increased, the risk of contamination is reduced and/or automation as well as disposal of the waste, for example the complete unit of rotor-stator-homogenizer, reaction vessel, and connection system, after homogenization and withdrawal of the homogenate, is simplified. Furthermore, the defined and standardized connection of the rotor-stator-homogenizer with the reaction vessel according to the present invention can allow to achieving a higher reproducibility of homogenizations. The defined anchorage between rotor-stator-homogenizer and reaction vessel clearly has the advantage to make the homogenization process more reproducible.

Aside the connection system of a rotor-stator homogenizer with a reaction vessel according to the present invention, another aspect of the invention is a device or a method in which homogenization surfaces on the rotor-stator-homogenizer, on the reaction tube, at the connection system or in form of homogenization particles are present.

An additional aspect of the invention is a device that is a rotor-stator-homogenizer that is not only used for homogenization but also for the transfer of material, e.g. solutions, reagents, homogenate, etc.

The connection of a rotor-stator-homogenizer with a reaction vessel is achieved through a connection system.

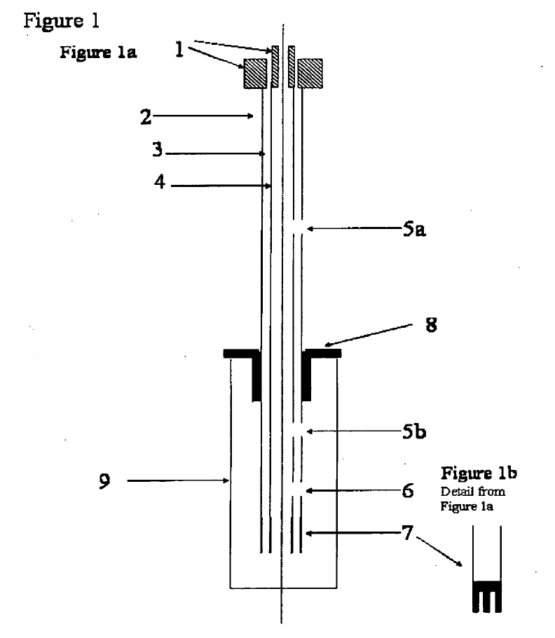

An example of a layout of a rotor-stator-homogenizer according to the invention is shown in FIG. 1. A coupling (1) connects the rotor-stator-homogenizer (2) with the drive system. The open top of the coupling can be dosed by a seal, for example with a lid, as the case may be a membranous seal, a septum, a fibrous web, etc. to prevent contamination and to enable an appropriate disposal. Through the open coupling or the open rotor-stator-homogenizer, substances can be added or removed. For instance, homogenate can be removed from the reaction vessel by pipetting. The rotor-stator-homogenizer (2) consist of a stator (3) and a rotor (4). Preferably, openings can be integrated. Besides a possible hole at a position outside the reaction tube to help air circulation (5a) the integration of a lower opening for circulation of solutions (6) is preferable. In a special embodiment, the upper opening for circulation of air outside the reaction tube (5a) can be abandoned. Instead, a corresponding opening within the rotor-stator-homogenizer can be inserted at a position within the reaction vessel (5b). Homogenate that leaves trough this opening (5b) cannot be spill out of the reaction vessel and cannot lead to contamination or losses. The openings can be placed exclusively in the stator (3) or exclusively in the rotor (4) or in both parts.

When a rotor does not consist of a hollow, cylindrical component, but does rather consist of a solid rod one can generally abandon the openings. The rotor-stator-homogenizer (2) has homogenization areas (7). Through at least one connection system (8) the rotor-stator-homogenizer (2) is joined with the reaction tube (9).

The rotor-stator-homogenizer, the reaction vessel and the connecting system consist of suitable materials, for instance, synthetic material or metal. Especially favored is the combination of a rotor-stator-homogenizer made of metal with a reaction vessel and a connecting system made of synthetic material or glass. Thus the rotor-stator-homogenizer can be reused. The homogenization vessel and if so the connecting system can be used to centrifuge the sample or can further be used for process steps like pipetting, incubation, etc, and finally can be disposed in a contamination low or contamination free manner. When the rotor-stator-homogenizer is not reused, particularly when the rotor-stator-homogenizer is made of plastic, it can be processed together with the reaction tube and the connecting system and be disposed in a sterile and in a contamination low or contamination free manner.

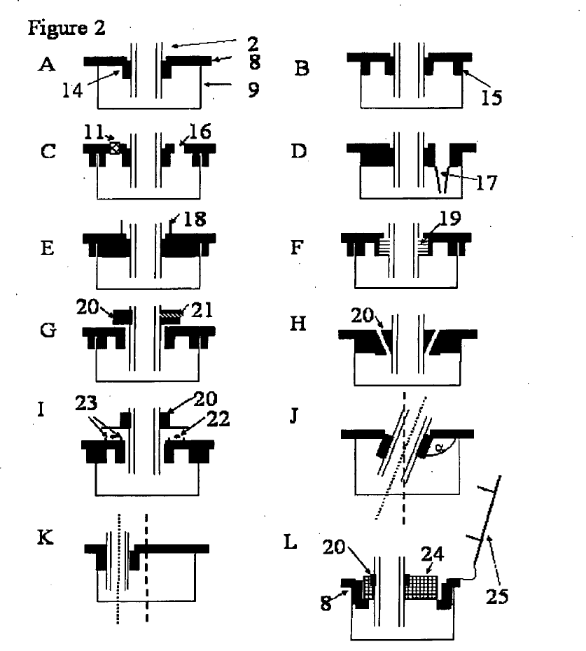

In the following, some examples for the connecting system are listed. Preferred connecting systems consist of units and elements which lead to a seal, whereas no material can leak or spill out of the reaction vessel or the rotor-stator homogenizer during homogenization or in following steps or at least minimizing leakage and/or allowing for a stable and/or defined position of the rotor-stator-homogenizer in the reaction vessel. Another aspect of connection systems according to the present invention can be a device that is used for the transfer material, e.g., solutions, reagents or homogenate, etc. FIG. 2A shows a connecting system (8) which is stacked on top of the circumferential edge of the reaction tube (9) and the rotor-stator-homogenizer (2), which is preferable tightly enclosed by a cylindrical area of the connecting system (14) and therefore acts as a guide conduct and as a detent respectively for the rotor-stator-homogenizer and prevents or reduces the leakage of solutions or homogenate out of the reaction tube. In FIG. 2B the connection system provides an additional guide conduct or detent (15), which is in direct contact with the inner surface of the reaction vessel, so that the connection system rests stably or in a defined manner in the reaction tube.

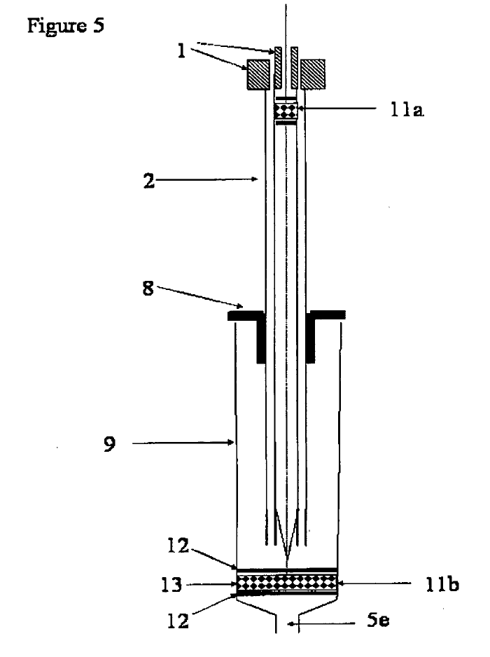

For example, the connecting system can be tightly connected with the reaction tube like a lid. The opening of the connecting system can have a breech or a lid also. The detent (15) can also be outside the upper brim of the reaction tube (FIG. 2C). The connecting system can have a separation unit (11) (separation units are described in more detail below, also see FIG. 5). In addition, the connection system may as well have openings for pressure compensation or pipetting. These openings can be branded with membranes, vales or lids or breeches. It is also conceivable, that the inner guide is constructed in a way that it is also used as a guide for the rotor-stator-homogenizer (FIG. 2D). In addition, a pipette tip, a guide for a pipette or a pipette tip or an adapter for a pipette (17) can be included in the connecting system. In another embodiment the connecting system is equipped with a border strip that provides further protection against spillage of solutions or homogenate and lowers the risk of contamination (FIG. 2E).

Besides simply plunging the rotor-stator-homogenizer in the guide of the connecting system, it would be also possible to build more rigid connections (FIG. 2F; 19), for instance spring locks, bayonet catches or screw joints. Such joints can not only be used on the assembly of connecting system and rotor-stator-homogenizer, but also in the assembly of connecting system and reaction tube. Through these connections, for example, the vertical position of the rotor-stator-homogenizer comparatively to the reaction vessel is additionally determined.

The vertical position of the rotor-stator-homogenizer can also be obtained with a stopper (FIG. 2G; 20). This stopper can be part of the rotor-stator-homogenizer that means for example tightly joined with one another. It is also conceivable that the stopper is attached to the rotor-stator-homogenizer in a ridged but flexible manner, for example trough instant spring locks, a bayonet catch or a screw joint, e.g. via a retaining screw (FIG. 2G; 21). In another embodiment (FIG. 2H) the stopper is conical and the connecting system is shaped accordingly and suitably.

To increase the closeness of the rotor-stator-homogenizer with the connecting system or the reaction vessel with the connecting system, seals or sealing systems can be used. As shown in FIG. 2I a gasket (21), e.g. an o-ring, which is preferably imbedded in a channel or cavity, can be used for this purpose. In combination with the stopper of the rotor-stator-homogenizer a respectively high impermeability is obtained in this way.

In a further embodiment (FIG. 2J) the connecting system is constructed in a way, that the vertical symmetry axis of the rotor-stator-homogenizer (dotted line) is not congruent with the vertical symmetry axis of the reaction vessel (dashed line), therefore, the angle α is not 90°. For instance, the introduction of an angle between 0.5° and 85°, between 1° and 40°, between 2° and 20° or between 3° and 10° can be an advantage. In another embodiment a flexible shank, for example via a flexible tube, allows for changing the angle manually or preferentially via an external drive mechanism. A flexible shank may also be achieved through the flexible connection of a stable, cylindrical shank with a stable lid. As flexible joints flexible synthetic materials can be chosen.

When a rotor-stator-homogenizer runs angular in relation to the reaction vessel, it has the surprising advantage of reducing or even inhibiting a swirl or a ‘homogenization funnel’ in the solution or homogenate in the centre of the reaction vessel in which the rotor-stator-homogenizer runs ‘empty’. This prevents a reduction in homogenization efficiency. Furthermore, foam formation is repressed, which would have a negative impact on yield. Foaming can result in denaturation processes of the sample which can negatively impact later analyses. Furthermore, the transfer, e.g. through a pipetting process or decanting of the sample out of the reaction vessel into another vessel, is aggravated by foam that had been generated. The loss of sample due to the transfer of foamed solution is considerable. According to the present invention these losses can be reduced.

In a further embodiment (FIG. 2K), the connection system is constructed in a way that the vertical symmetry axis of the rotor-stator-homogenizer (dotted line) is placed at a defined position which lies outside of the central, vertical axis of the reaction vessel (dashed line). This also prevents the formation of a swirl in the center of the reaction vessel in which the rotor-stator-homogenizer runs ‘empty’; with the same consequences as described above.

In a further embodiment the rotor-stator-homogenizer that is attached outside the center can be moved in the horizontal plane, preferentially in a circular way. This process can happen manually, but preferentially via a respective drive, to ensure a respective reproducibility. In this case for example, the connecting system possesses a cartridge (FIG. 2L; 24). This cartridge for example allows circular movements of the rotor-stator-homogenizer, which unexpectedly leads to a better homogenization.

In another embodiment cartridges or elements of the connection system of different size, for example, as shown In FIG. 2L; 24 are used to flexibly join differently sized rotor-stator-homogenizers and reaction tubes.

As previously described (FIG. 2F/G), the specified connection between the rotor-stator-homogenizer and the reaction vessel can determine the relative height. It is also possible to alter this relative height during the homogenization process. For example repetitive upward and downward movements are conceivable, which can be performed manually, preferentially however, by a respective drive, in order to warrant a respective reproducibility. These movements in the vertical plane can be combined with movements in the horizontal plane as well as with alteration of the angle either manually or preferentially however by a respective drive.

Surprisingly, these movements in a plane or in space lead to the fact that material that otherwise mainly abstracts from the homogenization process, is yet homogenized and this in particular when an automated and thus reproducible process is used.

In general, the embodiments can be equipped with a lid or a closure (25) that is shown as an example in FIG. 2L.

According to the present invention, the different aspects of the embodiments can be combined.

In another embodiment, the condition of the surfaces of the rotor-stator-homogenizer and/or the reaction vessel is as such, that the homogenization effect or homogenization efficiency is surprisingly increased significantly. This is achieved by using homogenization surfaces. Homogenization surfaces are characterized by the use of surfaces that have a rough texture that means for example that the surface area of a surface, in particular of a smooth surface, is enlarged. For example, rough surfaces can be generated by sanding, beveling, drilling, sand blasting, ultrasound, etching or other processes. For example, it is also conceivable, that an injection molding for plastic parts are not polished, but as the case may be particularly furnished with rough surfaces. As the case may be, plastic parts that have been produced in such a way have rough surfaces. It is also possible to place particles on top of surfaces to achieve a emery-paper-like surface. Free particles (homogenization particles) can also be used. This means, that homogenization surfaces can also be homogenization particles. Homogenization particles are solid particles, for example, glass, silica, titanium, magnetic particles and etc., which are added before or during the homogenization processes and which lead to an unexpected increase of the homogenization effect.

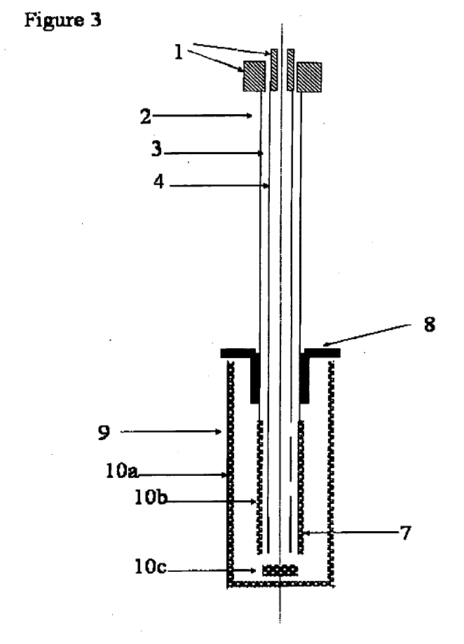

In FIG. 3 homogenization surfaces are present at the Inner surface of the reaction vessel (10a), at the rotor-stator-homogenizer (10b), in particular at the part that is introduced in the reaction tube, preferably on the outer surface of the stator, and/or in form of homogenization particles (10c).

For example, a system that does not allow for homogenization or disintegration of microorganisms without homogenization surfaces, may allow for homogenization or disintegration when homogenization surfaces, for example also homogenization particles, are present.

Surprisingly, the combination of homogenization surfaces with homogenization reagents results in unexpected high homogenization rates. Homogenization reagents are solutions or reagents which contain urea, detergents, organic solvents, chaotropic salts, enzymes etc. For example, sodiumdodecylsutfate, Tween detergents (like Tween 20), triton detergents (e.g. Triton X-100) are employed as detergents. Dimethylsulfoxide, methanol, ethanol or other substances used as organic solvents for instance. Chaotropic salts are for example guanidinium salts (e.g., guadininiumhydrochloride), sodium chloride or other salts at high concentration, etc. Detergents and chaotropic salts may also be present in a combination; for example guanidiniumdodecylsulfate. Enzymes are for instance hydrolases, in particular proteases (Proteinase K), muramidases, etc.

In addition, homogenization particles can be used for parallel or subsequent separation processes. Silical particles for example can be used for purification of nucleic acids.

The use of magnetic particles offers the advantage of performing subsequent, magnetically supported separation processes or extraction processes directly in the same reaction vessel without adding magnetic particles in an additional process step.

It is possible to reversibly magnetize the rotor-stator-homogenizer, so that the rotor-stator-homogenizer can be used for the reversible binding of the magnetic particles. This can be a great advantage for extraction- or purification steps, especially for their automation.

Beside particles, allowing for the performance of separation processes, membranes, filter, fibrous web, chromatographic units, etc. can be integrated in the rotor-stator-homogenizer, the reaction vessel or the connecting system. allowing the performance of separation processes.

In addition, openings, which allow for pipetting processes or separation processes, can be integrated in the rotor-stator-homogenizer, the reaction vessel or the connection system. In these openings septa, membranes, fillers or other penetrateable or under certain circumstances permeable systems can be present.

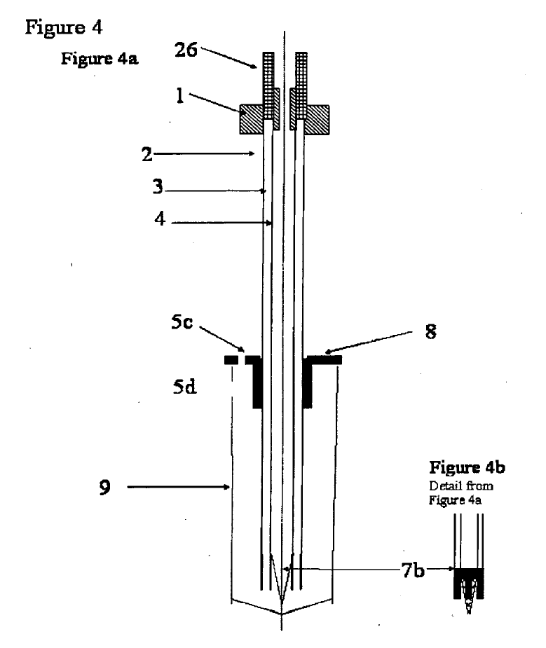

The rotor-stator-homogenizer shown in FIG. 4 can be used as a pipette for the addition of solutions, reagents, etc. and for the removal of homogenate as well as for the performance of separation steps. To achieve this, the coupling (1) is preferentially shaped in a way that it can be joined with a respective system for pipetting, e.g. a connection to a pumping system of a robot or a manual pipette.

To use the rotor-stator-homogenizer as a pipette it is preferred not to use openings in the rotor-stator-homogenizer. For pressure compensation, openings can be used in the connection system (5c) or the reaction vessel (5d) as the case may be with septa, valves, lids or other closures.

When solely the rotor (3) is used as a pipette, e.g., liquid or homogenate are moved in the inner part of the rotor, openings are preferably integrated within the stator (4). When both, the rotor (3) and the stator (4) are used as a pipette, i.e. liquid is moved in the inner part of a hollow rotor and/or in-between rotor and stator, openings are preferably integrated in the rotor.

In a special embodiment, the tip of the rotor-stator-homogenizer is shaped in a pointed manner or a pipette-like form, e.g. cone shaped (7b). The pipette-shaped tip can be located at the rotor or the stator. For an optimal uptake of solutions, preferentially, the tip is not shaped in a dentoid manner, but rather closed all around, in order to take up the liquid in an optimal fashion.

The usage of the rotor-stator-homogenizer as a pipette surprisingly leads to an increase of the yield and a reduction of the risk of contamination. Furthermore, the number of process steps is reduced. This facilitates the automation and the standardization and simplifies and accelerates processes and reduces costs.

In another embodiment (FIG. 5) separation units to perform separation procedures, extraction procedures or chromatographic procedures are provided (11). At least one separation unit is present. But multiple ones can be integrated also. These separation units can be placed in the rotor-stator-homogenizer (11a), the reaction vessel (11b) and also in the connection system (11c). The separation units can consist of a respective membrane or fibrous web, which is hooked in a suitable fitting (12). The separation units can also be built in a more complex way. For example, two membranes in an appropriate fitting (12) can enclose the material (13), which can be used for extraction procedures or chromatographic procedures. For example, this material can be hydroxylapatite, silica, sepharose, phenylsepharose, etc.

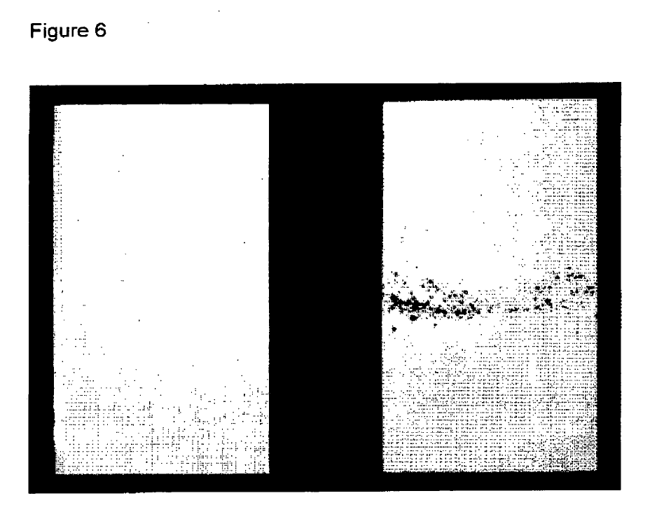

FIG. 6 displays the evidence that the use of a device as described in the present invention prevents the appearance of contamination in comparison to the state-of-art, shown by an example of carrying out the invention (example 1 of carrying out the invention). When a device according to the invention is used no contamination can be detected after a treatment of one minute (left picture). The connection system shown in picture 2B is used. Here the connection system is joined tightly as a lid with the reaction tube. In contrast, the device according to the state-of-art (without a connection system according to the invention), already shows marked contamination after treatment for 15 seconds (right picture). For the experimental proof that the device according to the present invention prevents contamination, 700 ml of a 2% aqueous Coomassie Brilliant Blue G 250 (CBB-) solution is transferred into a 2 ml reaction tube from the company Eppendorf (Hamburg, Germany). With the help of a Miccra 8 rotor-stator-homogenizer of the company Art moderne Labortechnik (Müllhausen, Germany) homogenization takes place at 33,000 min⁻¹ at room temperature. Spillage and thus contamination of the surrounding area is demonstrated with absorptive Whatmann paper from the company Schleicher and Schuell. Here, in each case the paper is wrapped cylindrically around the reaction tube and the rotor-stator-homogenizer.

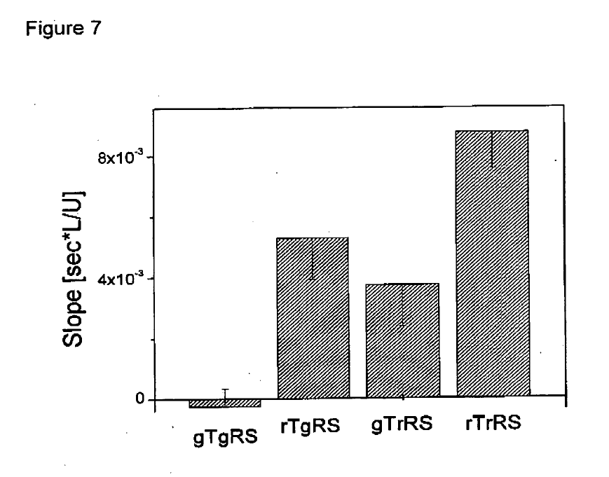

In FIG. 7 an example of carrying out the invention (example 2 of carrying out the invention) shows the dependency of the slope for the kinetic of the release of lactate-dehydrogenase from Escherichia coli DH5α (E. coli) by the used rotor-stator-homogenizer system. The slope is determined in the linear range. The slopes are given in seconds×liter/Units [sec*L/U]. The release of lactate-dehydrogenase from E. coli reflects the homogenization or the disintegration of this microorganism. For the experiments smooth reaction tubes with smooth rotor-stator-homogenizers (sTgRS), rough reaction tubes with smooth rotor-stator-homogenizers (rTgRS), smooth reaction tubes with rough rotor-stator-homogenizers (sTrRS) as well as rough reaction tubes with rough rotor-stator-homogenizers (rTrRS) are applied. The outer surface of the stator is roughened through sanding in case of the rough rotor-stator-homogenizer. The reaction vessels are roughened inside through drilling with a drill of an appropriate diameter. The experiments clearly show the higher efficiency of homogenization, when rough surfaces are used in contrast to smooth surfaces.

Example 3 of carrying out the invention

For the homogenization as well as for a potential subsequent purification of genomic DNA, homogenization particles, particularly magnetic particles are used as homogenization surfaces. The Dynabeads® DNA DIRECT™ Universal kit (Prod. No. 630.06 von Dynan) Biotech) is used for the experiments. Tissue from a vertebrate, in particular 50-100 mg flesh, is transferred into a reaction tube. 1.5 ml, 2 ml, 15 ml and 50 ml reaction vessels are used. Preferred are 2 ml reaction tubes from the company Eppendorf.

200 μl of a disintegration solution (lyses buffer of the Dynabeads® DNA DIRECT™ Universal kit) are pre-added in the reaction tube. On the one hand, homogenizations are performed where Dynabeads are present in the lyses buffer, on the other hand, homogenizations are performed where no Dynabeads are present in the lyses buffer. With the help of a Miccra rotor-stator-homogenizer homogenization is performed at a rotating speed between 10,500 and 39,000 min⁻¹, preferentially at 30,000 min⁻¹, at room temperature or cooled, with ice for instance. Duration of homogenization is between 2 and 60 seconds, preferentially 5 seconds. On the one hand, connection systems according to the present invention are used, in particular according to FIGS. 2 B, C and D. On the other hand, no connection systems are applied. When the connection systems according to FIGS. 2 C and D are used, sticky tape is used as a lead or breech for the openings (16, 17) during homogenization.

The homogenates of the experimental approaches are either used for subsequent purification of genomic DNA (see below) or treated as follows. Homogenate is withdrawn by pipetting and its volume determined. As the case may be, it can be necessary to cut off the pipette tip with an appropriate scissors or a knife in a way that an opening is generated that is wide enough to prevent clogging by pieces of tissue. As the case may be. this measure might also be necessary in other process steps and other embodiments. Thereafter a centrifugation step with 10,000 g for 10 minutes at room temperature takes place. The volume of the supernatant is determined. The absorption of the supernatant at 260 nm is measured after appropriate dilution with water. Additionally, after a suitable dilution in water, protein concentration is measured according to Bradford (Bradford, M. M. (1976) Anal. Biochem, 72, 248-254). The absorption at 260 nm and the protein concentration in relation to the amount of tissue applied are used as a measure for the efficiency of homogenization of a tissue (Vitzthum F. 2000 Entwicklung and Untersuchung automatisierungsgerechter physikalisch-mechanischer Desintegrationsverfahren für eine Nukleinsäure-gestützte, humanmedizinische Infektionsdiagnostik, Fraunhofer IRB Verlag. ISBN 3-8167-5582-8). Moreover, the yield of protein is determined as the product of the protein concentration and the volume of the supernatant.

In average, settings according to the presented invention with Dynabeads or connection systems and particularly the combination of both in relation to the amount of tissue used, results in higher absorptions, higher protein concentrations, higher homogenate volumes and/or total protein yields, in comparison to comparable settings without Dynabeads and/or connection systems.

Amongst other things, this is due to the connection system of the present invention, which reduces or prevents the spillage of samples out of the reaction tube. Herewith it is shown that the connection systems do not only reduce or prevent the risk of contamination, but also increase the volume yield and reproducibility of results. In particular, this is noticeable at long homogenization times, e.g. 60 seconds, if 2 ml collection tubes are used. As more material remains in the homogenization tube and is it therefore remains in the homogenization process for a longer period of time and is homogenized better, the efficiency is increased additionally.

In addition, the efficiency of homogenization is surprisingly increased by homogenization particles, especially in combination with a connection system. In particular when homogenized for a short time, for instance between 2 and 20 seconds, in 2 ml collection tubes and applying connection systems, the efficiency of homogenization in the presence of homogenization particles is higher than without those particles.

For the purification of genomic DNA, as usually common, homogenate is transferred to another reaction tube that contains Dynabeads that have been removed from the lyses buffer before. This step is time consuming, which is advantageously saved when Dynabeads are used directly in the disintegration solution during homogenization according to the present invention. As reaction vessels, the same vessels that have been used for the homogenization, preferentially 2 ml reaction tubes from the company Eppendorf, are used to perform subsequent process steps under comparable conditions. The transfer of homogenate is performed in a manner to allow for sufficient distribution of Dynabeads in the homogenate.

In the settings with connection systems according to FIG. 2 C or 2 D, the rotor-stator-homogenizer and the respective connection system are not removed during the process. The transfer of material takes place via the connection systems. This saves time.

Every setting is incubated at room temperature for 5 to 10 minutes. After this incubation, the reaction tubes are placed at or in a Dynal Magnetic Particle Concentrator (MPC). Preferentially, the magnet is first placed at the bottom of the reaction tubes. This is particularly important in those settings where the rotor-stator-homogenizer still is in the reaction tube to achieve a complete as possible collection of Dynabeads. When the Dynabeads have gathered, the magnet can be moved to the side to slide the beads to the side too. This facilitates the removal of supernatant by pipetting. Preferably the rotor-stator-homogenizer is moved a little upward, without removing it completely, though, from its initial position close to the bottom of the reaction vessel, which is resumed during homogenization.

After at least 1 to 2 minutes the supernatant can be removed by pipetting carefully. At the bottom of the reaction tube a brown, gel-like complex of Dynabeads and DNA has formed. It's important not to disturb this complex during subsequent processes. After transfer of the supernatant the reaction tube is removed from the Dynal MPC and 200 μl of washing buffer (10 mM Tris-HCl, pH 7.5, 150 mM LiCl, 0.1 mM EDTA) are added through pipetting. The reaction tube is replaced in or at the Dynal MPC thereafter. After the solution has cleared, the supernatant is removed. This washing procedure is repeated once. Thereafter the complex of beads and DNA is resuspended in 20-50 μl resuspension buffer (10 mM Tris-HCl, pH 8.0). For resuspension it is preferred to incubate at 65° C. for 5 minutes. The reaction vessel is placed in the Dynal MPC and after an incubation of 30 seconds the supernatant is withdrawn. After appropriate dilution in water DNA-concentration is measured at 260 nm (Vitzthum, F. and Bernhagen, J. (2002) SYBR Green I: An ultrasensitive fluorescent dye for double-stranded DNA quantification in solution and other applications; Recent Res. Devel. Anal. Biochem. 65-93, ISBN 381-7895-054-5).

On average higher DNA-concentrations are obtained when using Dynabeads or connection systems and especially their combination, if compared to comparable settings without Dynabeads and/or connection system. In this case, the use of connection systems according to FIG. 2 C and FIG. 2 D is especially preferred. In particular a connection system as in FIG. 2 C without a filter (11) but with an opening (16) is preferred.

Example 4 of carrying out the invention

This example of carrying out the invention describes exemplary the transfer of material through respective connection systems. A Miccra rotor-stator-homogenizer is used. As reaction vessels 50 ml centrifugation vials from Greiner are used. The upper part of the centrifugal vials is cut off approximately at the 20 ml mark. Lids of the centrifugal vials get a drilling in the centre of the lid or a drilling outside the central axis for the Miccra 8 rotor-stator-homogenizer and at least one additional drilling for a pipette tip outside the central axis. With hot-melt-adhesive (article 539500 by LUX-Werkzeuge) and a hot-glue-gun (KCK2002 by King Craft, Müller & Partner GbR), the rotor-stator-homogenizer is joined with the appropriate lid and its appropriate drilling to create systems as shown in FIG. 2 J, FIG. 2 K or combination of those. It is preferred to place the rotor-stator-homogenizer in a way that with a closed screw cap it is tilted pointing to the center of the bottom of the tapered reaction vessel and that the tip of the rotor-stator-homogenizer with its crushing parts is positioned approximately in the middle just above the pointed bottom of the reaction vessel. The lid is fixed to the reaction tube with hot-melt-glue. The positioning of the rotor-stator-homogenizer outside the central axis and/or with an appropriate angle (see FIG. 2 J) shows a reduced risk of the rotor-stator-homogenizer running ‘empty’ and thus increases the efficiency of homogenization.

At least one piece of tissue, e.g. 50 to 200 mg flesh, is placed in the reaction tube through the pipette-opening. Digestion solution is added through the pipette-opening by a pipette up to the level of 5 to 15 ml mark at the reaction vessel. As digestion solution phosphate buffered saline-solution pH 7.4 (PBS) is used for instance.

During the homogenization of 15 to 120 seconds at a rotational speed of around 30,000 min⁻¹ at room temperature without cooling, the opening can be closed by sticky tape or as shown in FIG. 2 D it is dosed with a pipette tip (17). Through this pipette-opening the detergent Triton X-100 is added up to a final concentration of 1% after homogenization. For equal distribution of the detergent, the tissue-homogenate is further homogenized for a short moment at minimal rotational speed. Alternatively, the rotor-stator-homogenizer can be removed from the drive and the reaction tube can be shaken carefully. The addition of detergent leads to a more complete and efficient homogenization of the tissue and in particular releases membrane bound substances, e.g., membrane bound proteins, if compared to the setting without detergent. In contrast to an addition of the detergent during the first homogenization, the addition of the detergent after the first homogenization leads to a lower foam-formation.

In such a process embodiments of connection systems as shown in FIGS. 2 C and D are preferentially applied, because these connection systems, in contrast to the connection systems without openings (16) or pipette tips (17). allow for a simple, fast, contamination free or contamination low, lossless or low-loss and automation-suited addition or removal of material, without detaching the reaction tube from the connection system or the rotor-stator-homogenizer from the connection system. Optionally a fitter (11) is integrated in this pipette tip as shown in FIG. 2 C.

The tissue homogenate is removed via a pipette tip. Additional PBS is added via the pipette tip and once more briefly homogenized and the homogenate removed by pipetting. This procedure is repeated twice. Thus protein recovery is increased (see below). The total volume of the homogenate of these steps is determined. Thereafter, a centrifugation at 10,000 g for 10 minutes at room temperature is performed. The volume of the supernatant is determined. The absorption of the supernatant at 260 nm is determined after appropriate dilution in water. In addition, after appropriate dilution with water the protein concentration is determined according to Bradford. The absorption at 260 nm and the protein concentration, in relation to the amount of tissue applied are used as a measure for the efficiency of homogenization of tissue. Furthermore, yield of protein is determined as the product of protein concentration and the volume of the supernatant.

On average, experiments performed with connection systems according to the present invention are convenient for the transfer of material, provide higher volumes of homogenate and related to the amount of tissue used, higher total absorption values, the product of the volume of the homogenate and the absorption per applied amount of tissue, and/or higher total protein yields, the product of the volume of the homogenate and the protein concentration per applied amount of tissue, if compared to comparable settings without connection systems.

Example 5 of carrying out the invention

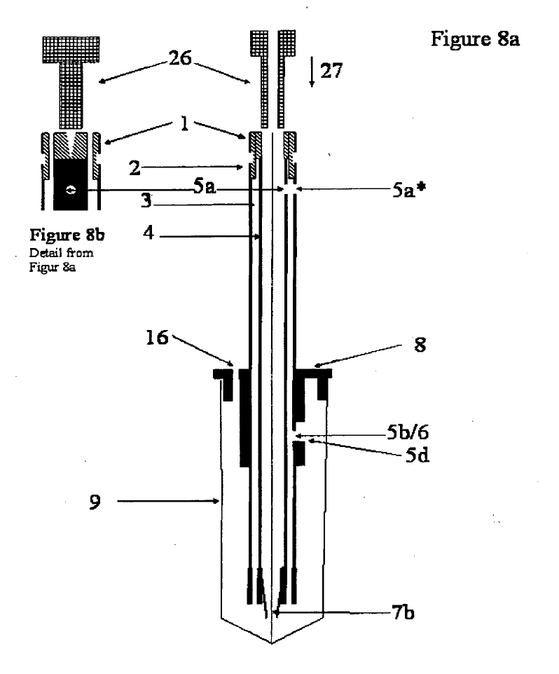

Here, a rotor-stator-homogenizer according to FIGS. 8a and 8b is used for the transfer material. In a hollow rotor a suitable shaped pipette tip (7b) is glued in according to FIG. 8a. For this purpose superglue gel by Tesa (Hamburg, Germany) is used for example. Openings of the rotor-stator-homogenizer are sealed with sticky tape and/or glue for example with the exception of the openings which allow air-circulation in the rotor (5a) and in the stator (5a*) or the circulation of air or solutions in the stator (5b/6). A connection system according to FIG. 2 B is used. This connection system has according to an additional embodiment as shown in FIG. 8a an extra opening (5d) which function is discussed below.

Water and salad oil are transferred into a reaction vessel. Homogenization is performed at minimal speed for a short period. The resulting suspension is removed via the rotor-stator-homogenizer.

This happens for instance via the rotor. A pipette, a pipette tip or another suitable system to produce a pressure change (26), for example a negative pressure for the withdrawal of material or a positive pressure for the addition of material, that is precisely tailored to connect with the rotor or the rotor-stator-homogenizer, is fitted in the rotor (arrow 27) or as the case may be between the rotor and the stator to dose the opening in the rotor (5a). To illustrate this, the performed procedure is displayed in FIG. 8b by a cross section of the stator and the view from the top of the rotor and the system showing the generation of pressure changes (26). In this example carrying out the invention, a suitable pipette tip is cut and changed in such a way with hot-melt-glue that a structure according to FIG. 8a or 8b or be is furnished.

The opening (5a) in the rotor can be closed alternatively from the outside with a plug for instance. To do so, the openings in the rotor (5a) and in the stator (5a*) have to be congruent however, to close the opening in the rotor (5a) through the opening of the stator (5a*).

When low pressure is generated via a pipette or another respective system, the suspension is transferred via the pipette tip at the rotor (7d) into the rotor by the air-pressure which pushes the suspension in the rotor through the opening at the stator (5a*) or via possible openings in the connection system (16). The rotor-stator-homogenizer is then used as a pipette tip, i.e. is removed out of the reaction vessel and the suspension contained within the rotor transferred into another reaction vessel. Alternatively, suspension can be removed from the reaction tube via the rotor-stator-homogenizer which remains in the reaction vessel.

Respectively large volumes and solutions, suspensions and homogenates with respective viscosity can be transferred with the above stated device according to the present invention and method by using a rotor or a rotor-stator-homogenizer without a pipette tip (7b). However, the use of a pipette tip is preferred, because some solutions can only be transferred with such a tip and/or less or no residual solution remains in the reaction tube and therefore the yields can be increased with a pipette tip at the rotor-stator-homogenizer.

Material transfer in or out of the reaction is preferably done via the rotor, in particular, when the rotor-stator-homogenizer is used as a type of pipette tip. This is advantageous, when the rotor-stator-homogenizer is removed from the system that generates pressure changes, after material has been transferred, because this way the risk of leakage of material is reduced. Another possibility to transfer material, according to the present invention, is the use of pressure changing systems (26) which fit exactly on the outer part around the stator. These are pulled or pushed over the stator so that the opening at the stator (5a*) is closed from the outside. If the case may be, the gap between stator and rotor is also sealed by this. Due to pressure differences it can be reasonable to use stators that do not have the openings 5b/6 (FIG. 8a).

In another embodiment, stators that have the openings 5b/6 (FIG. 8a) are used in conjunction with connection systems that have a least one opening 5d (FIG. 8a). During the homogenization the rotor-stator-homogenizer has a position in which the opening or the openings of the stator are congruent with the openings of the connection system so that the circulation of air or material is possible. Through a change of the position of the stator relative to the connection system at least one opening of the stator can be closed. This is utilized for the removal of material.

The rotor-stator-homogenizers and procedures according to the present invention, which are suitable for the transfer of material, especially in combination with the connection systems of the present invention, allow a simpler and faster transfer of material, i.e. in this case a suspension of water and salad oil, and on average higher yields if compared to comparable homogenizations, where the homogenate is removed in a traditional manner, e.g., by decanting or pipetting, in particular, when nor connection systems according to the present invention are used.

Example 6 of carrying out the invention

Rotor-stator-homogenization of plant material performed in connection with a reaction tube including a separation unit for the filtration of the homogenate. Material from the NucleoSpin® Plant XL Kits from Macherey & Nagel (Düren, Germany) is used for this purpose. Leaves from a plant, e.g., those from Crassula (Pfennigbaum), are transferred to a NucleoSpin® filter unit, which is similar to a reaction tube as described in FIG. 5. The outlet of the NucleoSpin® unit is closed. As shown in FIG. 2C, a rotor-stator-homogenizer is joined via a connection system without a separation unit to the NucleoSpin® filter unit. Through the opening 16 of the connection system ‘buffer C1’ from the kit is pipetted into the vessel. The volume of the added ‘buffer C1’ corresponds to the volume as recommended in the instruction manual of the kit for the respective amount of plant material. Opening 16 is closed with a sticky tape. Homogenization is performed at room temperature at a rotational speed of 30,000 min⁻¹ between 5 seconds and 2 minutes. The sticky tape is removed after homogenization and per mg of plant material 80 μl RNase A solution from the kit is added through opening 16. Incubation is performed at 80° C. for 30 minutes. The breech of the outled of the NucleoSpin® Filter unit is removed. By applying high pressure through the rotor-stator-homogenizer or the connection system and whilst appropriate openings in the rotor-stator-homogenizer and/or the connection system are dosed, the homogenate is pushed through the NucleoSpin® filter unit. The filtered homogenate is captured in a reaction vessel and can be further processed following the instruction manual if required. When using the connection system and combining it with a separation unit according to the present invention, especially an integrated filter unit in the reaction vessel, is used, the usual step of changing the reaction tube is omitted. The average process time is shortened and the yields are increased.

The embodiments and itemized processes and devices of the present description can be combined and applied in an advantageous manner according to the respective requirements of a respective combination according to the present invention.

1. Device for the rotor-stator homogenization of inhomogeneous samples, whereas
a. a rotor-stator-homogenizer and a reaction tube connected by a connection system and/or
b. homogenization surfaces and/or
c. a rotor-stator-homogenizer, that is suitable for the transfer material, is applied.

2. Device according to claim 1, whereas the connection system joins the rotor-stator-homogenizer and the reaction vessel in a way that the rotor-stator-homogenizer is located at a defined position within the reaction vessel.

3. Device according to claims 1 or 2, whereas the connection system joins the rotor-stator-homogenizer with the reaction tube in a way that undesired exit of material is prevented or reduced.

4. Device according to claims 1 to 3, whereas the rotor-stator-homogenizer, the reaction vessel or the connection system is made of synthetic material or metal.

5. Device according to claims 1 to 3, whereas the reaction vessel or the connection system is made of glass.

6. Device according to claims 1 to 5, whereas the connection system joins the rotor-stator-homogenizer with the reaction vessel in a way that the rotor-stator-homogenizer is placed at a right angle but outside the central, vertical axis of the reaction vessel.

7. Device according to claims 1 to 6, whereas the connection system joins the rotor-stator-homogenizer with the reaction vessel in a way that the vertical-symmetry-axis of the rotor-stator-homogenizer is not parallel with the vertical-symmetry-axis of the reaction vessel.

8. Device according to claims 1 to 7, whereas the rotor-stator-homogenizer and the reaction vessel are free to move relative to each other.

9. Device according to claims 1 to 8, whereas the rotor-stator-homogenizer, the connection system and/or the reaction vessel exhibit openings for the transfer, the addition or the removal of solutions, reagents, and homogenate.

10. Device according to claims 1 to 9, whereas the reaction vessel, the connection system and/or the rotor-stator-homogenizer contain at least one separation unit to perform separations procedures, extraction procedures or chromatography procedures.

11. Process for the homogenization of inhomogeneous samples, whereas a device according to one of the claims 1-10 is used.

12. Process according to claim 11, whereas disintegration solution is used.

13. Process according to claim 11 or 12, whereas magnetic homogenization particles are used.
